(19) United States
(12) Patent Application Publication
(10) Pub. No.: US 2003/0085494 A1
(43) Pub. Date: May 8, 2003

(54) Method for producing ceramic laminate

(76) Inventors: Akio Iwase, Nishio-City (JP); Yukihisa Takeuchi, Chita-gun (JP); Shoji Osaki, Okazaki-City (JP); Tetsuji Ito, Kariya-City (JP); Toshio Ooshima, Obu-City (JP); Shige Kadotani, Chita-gun (JP)

Correspondence Address: Nixon & Vanderhye P.C., 8th Floor, 1100 North Glebe Road, Arlington, VA, 22201-4701, US

(21) Appl. No.: 10/284,332

(22) Filed: Oct. 31, 2002

(30) Foreign Application Priority Data
Nov. 7, 2001 (JP) 2001-342361
Jul. 26, 2002 (JP) 2002-218419

(51) Int. Cl. B28B 1/00; B28B 3/00; B28B 5/00

(52) U.S. Cl. 264/614

(57) ABSTRACT

A method for producing a ceramic laminate includes a sheet-forming process for forming a green sheet 11 by placing a raw ceramic material on a carrier film 12, a punching process for punching a green sheet piece of a predetermined shape from the green sheet, a stacking process for sequentially stacking a plurality of the green sheet pieces to form a green laminate, and a calcination process for calcining the green laminate to obtain a ceramic laminate consisting of a plurality of ceramic layers, wherein, in the punching process, the green sheet piece only is punched while the green sheet 11 is held on the carrier film 12.

Thus, a ceramic laminate free from defects, due to folding, creasing, cracking or dry shrinkage of the green sheet piece, is obtainable.

### BACKGROUND OF THE INVENTION

1. Field of the Invention

The present invention relates to a method for producing a ceramic laminate obtained by stacking a plurality of ceramic layers.

2. Description of the Related Art

For example, a laminate type piezoelectric element is formed by using a ceramic laminate formed by stacking ceramic layers, and is used as a laminate type piezoelectric actuator or a laminate type piezoelectric transformer.

When the above-mentioned ceramic laminate is produced, a raw material of piezoelectric ceramics such as lead zirconate titanate (PZT) is first added with a binder and a very small amount of plasticizer and defoamer. Then, this raw material is dispersed into an organic solvent to result in a slurry.

The slurry is coated on a carrier film by a doctor-blade method or others to produce a green sheet of a predetermined thickness. Then, the green sheet is peeled off from the carrier film as an independent sheet.

Next, An Ag—Pd paste is printed as inner electrodes on a surface of the green sheet.

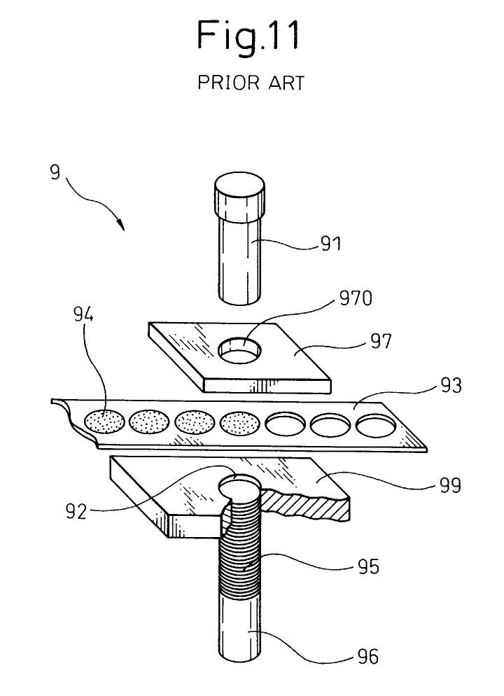

As shown in FIG. 11, pieces of the green sheet are punched out from the green sheet 93 carrying the inner electrodes 94 by using a press machine 9 having a punch 91 and a die 99, and are stacked together.

The punch 91 is coupled to a hydraulic cylinder not shown to be subjected to an upward and downward stroke. The die 99 is provided with a through-hole 92 having a cross-section generally the same as that of the punch 91. The punch 91 is adapted to enter the through-hole 92 at a bottom dead center of the stroke. Also, on the extension of a center axis of the through-hole 92 of the die 99 and the punch 91 is disposed a laminate holder 96 having a cross-section generally the same as that of the punch 91. The laminate holder 96 is adapted to be movable upward and downward on the axis of the through-hole 92 of the die 99. Above the die 99 is disposed a presser plate 97 having a through-hole 970.

The press machine thus structured repeats a series of operations of intermittently feeding the green sheet 93 a predetermined distance, pressing the same by the presser plate 97, and moving the punch 91 downward to penetrate the through-hole 92 of the die 99 via the through-hole 970. Thereby, the green sheet pieces are sequentially punched out from the green sheet 93 placed on the die 99. The green sheet pieces thus obtained are sequentially stacked via the through-hole 92 on the upper surface of the laminate holder 96 to form a green laminate 95. At this time, the laminate holder 96 gradually descends in accordance with the number of the green laminates 95 while holding a lower end surface of the green laminate 95 thereon.

Then, the green laminate 95 obtained by stacking a plurality of green sheet pieces as described above is thermally press-bonded and calcined at a temperature in a range from 1000 to 1400° C. to result in a ceramic laminate.

However, most of the green sheets 93 have a thickness of 300 μm or less and, therefore, are thin and weak. Accordingly, an individual green sheet 93 is liable to fold, crease or crack. The crack of the sheet is of course problematic. Inner stress is generated in the green sheet 93 by the folding of the sheet to cause cracking during calcination.

Also, as the green sheet 93 is free from a constraint of the carrier film if the green sheet 93 is peeled off from the carrier film, the dry shrinkage progresses as the green sheet 93 is drying. Therefore, the accuracy in the position of the printed inner electrode or in the punched shape of the green sheet piece may vary to deteriorate the precision of the resultant ceramic laminate.

On the other hand, there are various proposals for methods for producing the ceramic laminate, particularly for stacking a number of green sheets (for example, Japanese Unexamined Patent Publication No. 7-122457 and Japanese Opening Patent Publication No. 2000-500925). However, no countermeasures for preventing the folding, creasing or cracking of the green sheet are disclosed in these prior art methods.

### SUMMARY OF THE INVENTION

The present invention has been made to solve the above-mentioned problems of the prior art, and an object thereof is to provide a method for producing a ceramic laminate having no drawbacks therein caused by the folding, creasing, cracking or dry shrinkage of the green sheet.

According to one aspect of the present invention, a method for producing a ceramic laminate, comprising a sheet-forming process for forming a green sheet by placing a raw ceramic material on a carrier film, a punching process for punching a green sheet piece of a predetermined shape from the green sheet, a stacking process for sequentially stacking a plurality of the green sheet pieces to form a green laminate, and a calcination process for calcining the green laminate to obtain a ceramic laminate consisting of a plurality of ceramic layers wherein, in the punching process, only the green sheet piece is punched while holding the green sheet on the carrier film.

In the above-mentioned invention, the green sheet piece is punched from the green sheet which is not peeled off from the carrier film but maintained to be held thereon, as described above.

That is, in the punching process, the punching of the green sheet is carried out while the green sheet is in tight contact with the carrier film so that the shape thereof is constrained.

Thus, in the punching process, it is possible to obtain the green sheet piece while scarcely generating fold, crease, crack or dry shrinkage. Thereby, the ceramic laminate obtained thereafter via the piling process, the calcination process or others has a superior quality free from cracking or other problems.

As described above, according to the above-mentioned invention, it is possible to provide a method for producing a ceramic laminate having no defects therein caused by the folding, creasing, cracking or dry shrinkage of the green sheet.

According to another aspect of the present invention, a method for producing a ceramic laminate, comprising a sheet-forming process for forming a green sheet by placing a raw ceramic material on a carrier film, a printing process for printing a paste for an electrode on the green sheet, a punching-stacking process for punching a green sheet piece of a predetermined shape from the green sheet and sequentially stacking the green sheet pieces to form a green laminate, and a calcination process for calcining the green laminate to obtain a ceramic laminate in which a ceramic layer and an electrode layer are alternately stacked, wherein in the punching-stacking process, the green sheet piece is punched by using a Thomson punch having a central space and is sequentially stacked in the central space.

Accordingly, it is possible to carry out the punching while holding the green sheet on the carrier film in tight contact therewith in the punching-stacking process, whereby the green sheet piece free from folding, creasing, cracking or dry shrinkage is easily obtainable. Further, as the stacking of the green sheet piece is carried out within the central space of the Thomson punch simultaneously with the punching thereof, it is possible to form a green laminate while maintaining a superior quality of the individual green sheet piece free from folding or other problems. As a result, the ceramic laminate obtained thereafter via the calcination process has a superior good quality free from cracking or other problems.

According to the above-mentioned invention, it is possible to provide a method for producing a ceramic laminate having no defects therein caused by the folding, creasing, cracking or dry shrinkage of the green sheet.

The present invention may be more fully understood from the description of the preferred embodiments of the invention, as set forth below, together with the accompanying drawings

### BRIEF DESCRIPTION OF THE INVENTION

In the drawings:

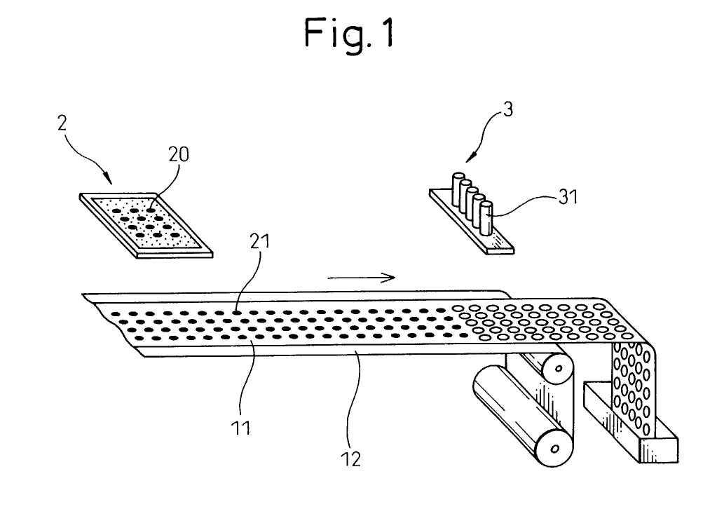

FIG. 1 illustrates an inner electrode printing process and a punching process in a series of processes for producing a ceramic laminate according to a first embodiment of the present invention;

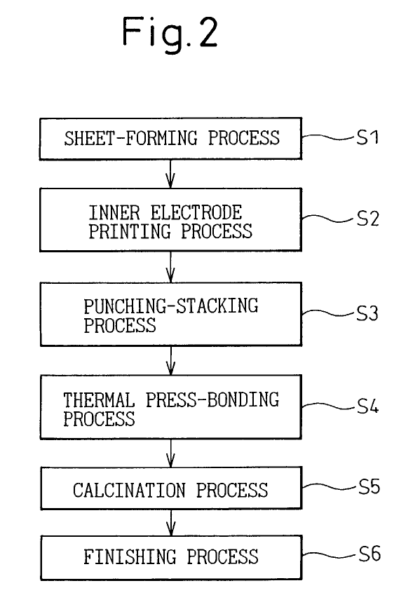

FIG. 2 is a flow chart of the series of processes for producing the ceramic laminate according to a first embodiment of the present invention;

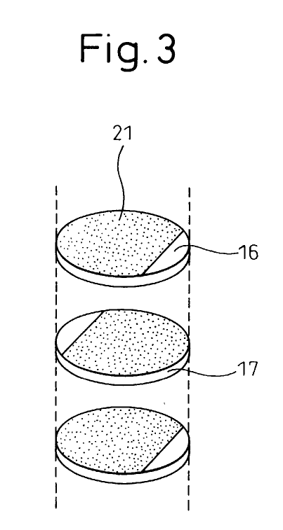

FIG. 3 is a perspective view of green sheet pieces prior to being stacked in the first embodiment;

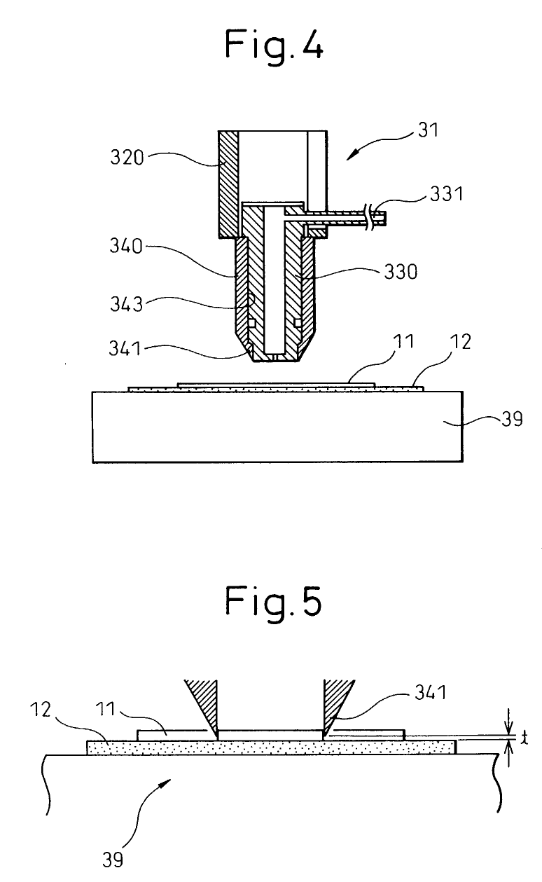

FIG. 4 is a side sectional view of a Thomson punch used in the first embodiment;

FIG. 5 is an enlarged side sectional view of an edge of the Thomson punch at a bottom dead center in the first embodiment;

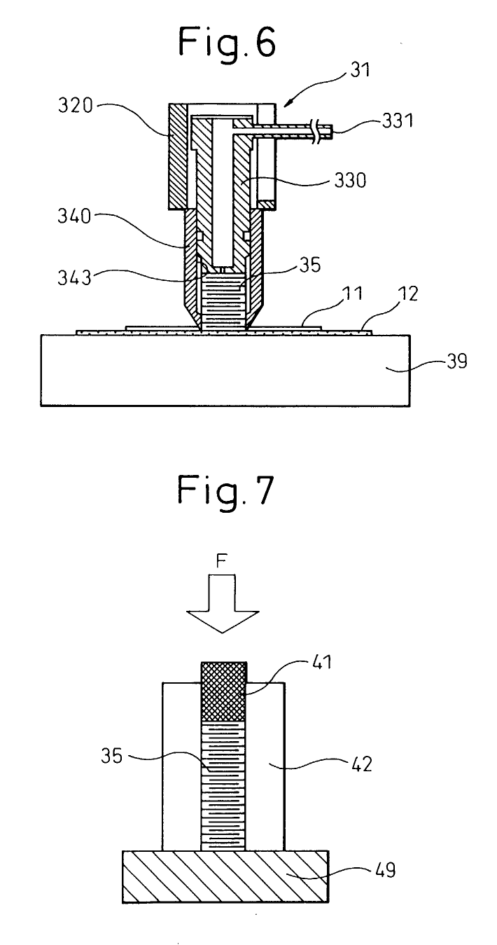

FIG. 6 is a side sectional view illustrating the punching and stacking by means of the Thomson punch at the bottom center thereof in the first embodiment;

FIG. 7 is a side sectional view of a thermal press-bonding device used in the first embodiment;

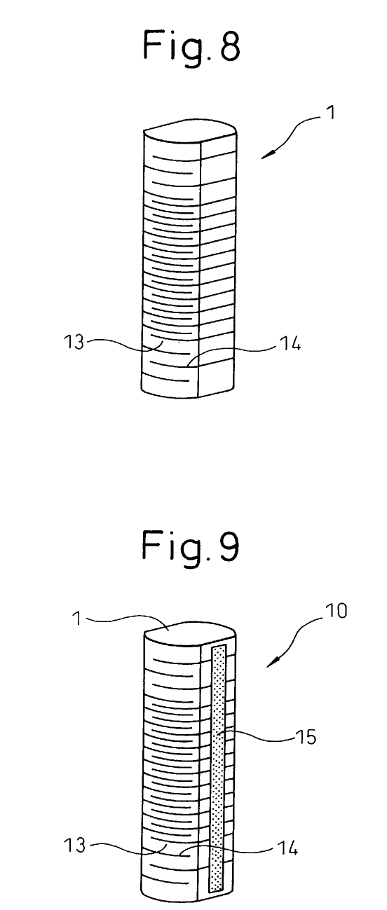

FIG. 8 is a perspective view of a ceramic laminate formed to have a barrel shaped cross-section in the first embodiment;

FIG. 9 is a perspective view of a laminate type piezoelectric element in the first embodiment;

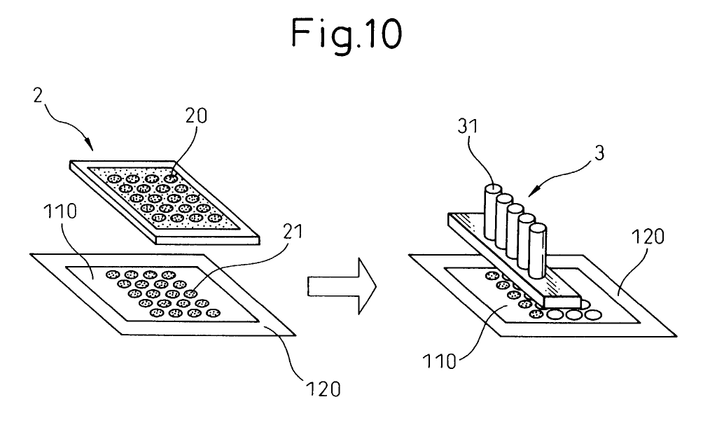

FIG. 10 illustrates an inner electrode printing process and a punching process in a series of processes for producing a ceramic laminate according to a second embodiment of the present invention;

FIG. 11 illustrates a punching process in a series of processes for producing a ceramic laminate in the prior art;

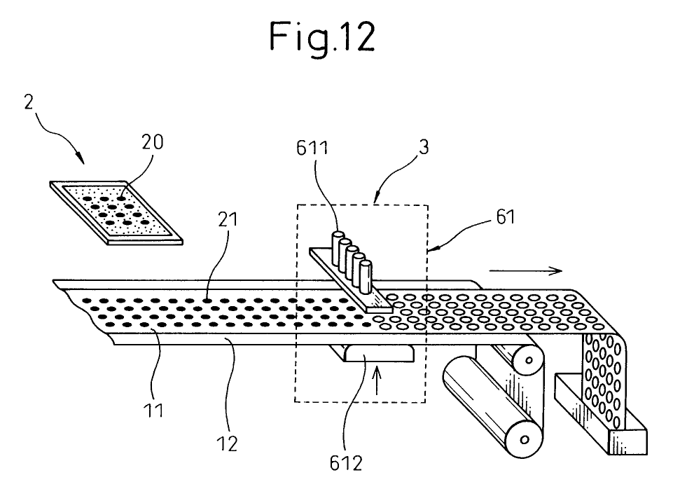

FIG. 12 illustrates an inner electrode printing process and a punching process in a series of processes for producing a ceramic laminate according to a third embodiment of the present invention;

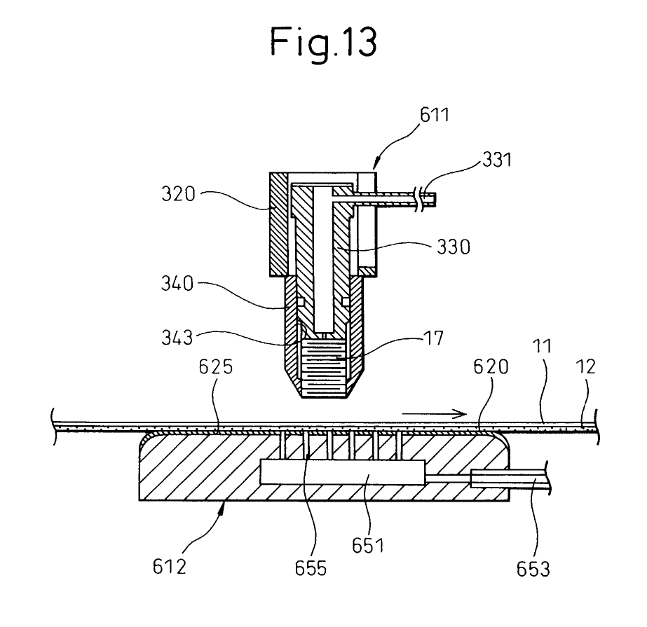

FIG. 13 is a side sectional view of a punching-stacking device used in the third embodiment;

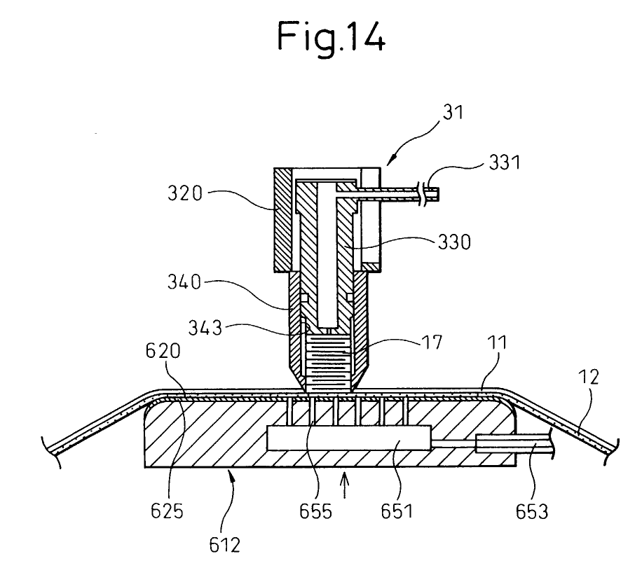

FIG. 14 illustrates the punching of a green sheet piece by the punching-stacking device in the third embodiment; and

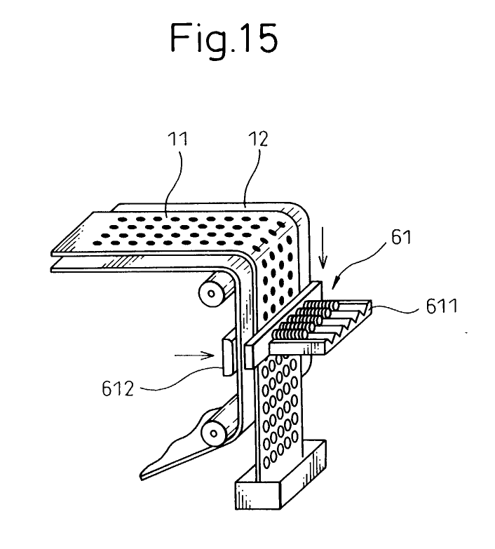

FIG. 15 is a perspective view another punching-stacking device used in the third embodiment;

### DESCRIPTION OF THE PREFERRED EMBODIMENTS

(First Embodiment)

A method for producing a ceramic laminate according to this embodiment will be described with reference to FIGS. 1 to 9.

This embodiment is a method for producing a ceramic laminate 1, comprising a sheet-forming process S1, an inner electrode printing process S2, a punching-stacking process S3, a thermal press-bonding process S4, a calcination process S5 and a finishing process S6 wherein, in the punching-stacking process, only a green sheet piece is punched.

In the sheet-forming process S1, a green sheet is prepared by coating a piezoelectric material on a carrier film to have a predetermined thickness.

In the inner electrode printing process S2, inner electrodes are printed on the green sheet.

In the punching-stacking process S3, the punching, stacking and pressing of the green sheet pieces are simultaneously carried out by using a Thomson punch to form a green laminate.

In the thermal press-bonding process S4, the green laminate formed in the Thomson punch is thermally press-bonded.

In the calcination process S5, the green laminate is calcined to be a ceramic laminate.

In the finishing process S6, the ceramic laminate is machined to have a predetermined shape.

Details of the above processes will be described below.

As shown in FIG. 8, the ceramic laminate 1 is formed by stacking 500 ceramic layers 13 together, each having a diameter of 11.4 mm and a thickness of 80 μm. Particularly, in this embodiment, the ceramic laminate 1 forms a laminate type piezoelectric element 10 as shown in FIG. 9, in which the ceramic layer 13 and an inner electrode layer 14 are alternately stacked.

In this embodiment, a carrier film 12 wound in the longitudinal direction to form a roll is used when the ceramic laminate 1 is produced. As shown in FIG. 1, the carrier film 12 withdrawn from the roll is placed on a working table not shown and intermittently runs forward so that the sheet-forming process S1, the inner electrode printing process S2 and the punching-stacking process S3 are sequentially carried out. As shown in FIG. 1, after finishing the punching-stacking process S3, the green sheet 11 and the carrier film 12 are separated from each other, and the green sheet 11 is collected into a recovery box and the carrier film 12 is wound by a winding device not shown, respectively.

In the sheet-forming process S1, a slurry for the green sheet is coated on the carrier film 12 by a doctor blade method to result in the green sheet 11.

The slurry for the green sheet is prepared by the following steps:

First, a raw material of a piezoelectric ceramic such as lead zirconate titanate (PZT) is added with a binder and a very small amount of plasticizer and defoamer. Then, this raw material is dispersed into an organic solvent to result in the slurry.

This slurry is coated on the carrier film 12 by a doctor blade method to form the green sheet 11 of a predetermined thickness.

In this regard, there are various methods for forming the green sheet 11 from the slurry, other than the doctor blade method, such as an extrusion molding method.

Then, as shown in FIG. 1, in the inner electrode printing process S2, an inner electrode 21 is printed on the green sheet 11 formed on the carrier film 12. In this embodiment, the inner electrode 21 is screen-printed with an Ag—Pd paste. At this time, a pattern shown in FIG. 3 is adopted so that an insulated portion 16 is formed adjacent to the inner electrode 21 on the surface of the green sheet piece 17 punched in the punching-stacking process S3 described later.

Next, the punching-stacking process S3 for producing the ceramic laminate 1 as shown FIG. 1 will be described in more detail below.

A punching-stacking device 31 shown in FIG. 4 is applied to the punching-stacking process S3. The punching-stacking device 31 has a Thomson punch holder 320 subjected to the upward and downward stroke in conformity with the movement of a hydraulic cylinder not shown, the Thomson punch 340 having a central space 343, and a stacking weight 330 slidable in the central space 343 in the vertical direction. As shown in FIG. 1, a five-coupled punching-stacking device 3 in which five of the Thomson punches 340 are connected together is used so that a plurality of punching-stacking processes S3 are simultaneously carried out.

The Thomson punch 340 is adjusted so that a predetermined gap is formed between an edge 341 thereof and an upper surface of the working table 39 at the bottom dead center of the stroke thereof. In this respect, the predetermined gap is a gap t in FIG. 5 corresponding to a thickness of the carrier film 12 plus 5 to 10% of a thickness of the green sheet 11. Accordingly, the edge 341 of the Thomson punch 340 can reach a position corresponding to 90 to 95% of the thickness of the green sheet 11 but does not arrive at the carrier film.

A proper punching force was determined by an experiment under the above-mentioned condition. As a result, it was found that a proper range of the punching force is from 25 to 50 N. If the punching force is less than 25 N, there is a case wherein the green sheet 11 is insufficiently cut to result in the incomplete punching of the green sheet piece 17. Contrarily, a punching force exceeding 50 N is unnecessary.

As shown in FIG. 4, the stacking weight 330 is provided with a suction port 331 connected to a vacuum pump not shown and has a weight of 11.4 g. The suction port 331 connects to the stacking weight 330 opening at a lower end surface of the stacking weight 330 to suck air. Thus, the lower end surface of the stacking weight 330 defines a suction surface.

In this embodiment, the punching and the stacking of the green sheet pieces 17 are simultaneously carried out by using the punching-stacking device 31 thus structured.

First, the lower end surface of the stacking weight 330 is adjusted to be approximately flush with the edge 341 of the Thomson punch 340, and then a first green sheet piece 17 on which no inner electrode 21 is printed is punched. This green sheet piece 17 is brought into contact with the lower end surface of the stacking weight 330 and sucked thereto simultaneously with the punching. Thereafter, as the Thomson punch holder 320 moves upward, this green sheet piece 17 is cut off from the green sheet 11 and taken into the central space 343 of the Thomson punch 340.

Next, the carrier film 12 carrying the green sheet 11 is fed at a predetermined distance to make a portion of the green sheet 11, on which the inner electrode 21 is printed, coincide with a punching position of the Thomson punch. In this state, the green sheet piece 17, on which the inner electrode 21 is printed, is punched by the Thomson punch 340. This green sheet piece 17 is adhered to the lower end surface of a green piece laminate 35 stacked in the central space 343 of the Thomson punch 340 by the viscosity of the printed inner electrode 21 (Ad-Pg paste). As the Thomson punch holder 320 moves upward, the green sheet piece 17 is cut off from the green sheet 11 and forms part of the green sheet laminate 35 in the central space 343 of the Thomson punch 340. The above-mentioned operation cycle of feeding the carrier film 12 at a predetermined distance, punching the green sheet 11 and stacking the green sheet piece 17 is repeated. In such a manner, the green sheet pieces 17 are sequentially punched, cut off and stacked. As a result, the green laminate 35 consisting of a predetermined number of stacked green sheet pieces 17 is obtained.

A pressure caused by a weight of the stacking weight (11.4 g) is applied to the green laminate 35 in the central space 343 of the Thomson punch 340. That is, the green laminate 35 stacked in the interior of the Thomson punch 340 is pressed so that the green sheet pieces are brought into tight contact with each other.

In this regard, while the above-mentioned pressure may vary in accordance with the cross-sectional area of the green laminate 35, 10 g to 1.5 kg is proper. If the pressure is less than 10 g, there is a risk that the green sheet pieces are not sufficiently brought into tight contact with each other. On the other hand, if it exceeds 1.5 kg, there is a risk that the green laminate 35 falls out from the central space 343 of the Thomson punch 340.

In this embodiment, by taking the relationship between the gravity force applied to the green laminate 35 and a vertical frictional force applied to the outer circumference of the green laminate 35 into consideration, the weight of the stacking weight is determined. The green laminate 35 in the central space 343 is pressed by a force of 11.4 g which is a weight of the stacking weight so that the green sheet pieces 17 are in tight contact with each other. On the other hand, as the gravity force caused by the stacking weight is smaller than the vertical frictional force, the green laminate 35 in the central space 343 of the Thomson punch 340 is prevented from falling out therefrom.

The stacking weight 330 is gradually pushed up as a length of the green laminate 35 increases, while continuously applying a proper pressure to the green laminate 35. Therefore, the lower end surface of the green laminate 35 is automatically regulated to be always approximately flush with the edge 341 of the Thomson punch 340. Accordingly, in the punching-stacking process S3, it is possible to continuously and automatically carry out the cycle from the punching to the stacking.

Next, as shown in FIG. 7, according to this embodiment, the thermal press-bonding process S4 is carried out on the green laminate 35 produced by the punching-stacking device 31. The green laminate 35 is pressed in the axial direction while being held at the outer circumference and the end surface thereof. In this embodiment, the green laminate 35 is heated at an atmospheric temperature of 80° C. for 30 minutes, and thereafter pressed by applying a pressing force F of 4 kgf for 15 seconds.

Then, in the calcination process S5, the green laminate 35 is calcined. In this embodiment, after maintained at a temperature of 1200° C. for 2 hours, the green laminate 35 is cooled in a furnace to be a ceramic laminate 1 having a circular cross-section not shown.

Then, the finishing process S6 is carried out. In this embodiment, as shown in FIG. 8, the ceramic laminate 1 is machined to have a barrel-shaped cross-section.

In this embodiment, the machining is carried out by using a cylindrical grinder and a planing machine not shown. First, the outer circumference of the ceramic laminate 1 having a circular cross-section is machined by using the cylindrical grinder to have a predetermined circularity. Then, by using the planing machine, the circumference of the ceramic laminate 1 is machined to have opposite two flat portions extending parallel to each other in the axial direction, to result in the barrel-shaped cross-section.

Thereafter, an external electrode 15 is attached so that a laminate-type piezoelectric element is obtained from the ceramic laminate 1.

As shown in FIG. 9, to facilitate the attachment of the external electrode 15, the circumferential shape of the ceramic laminate 1 has a barrel-shaped cross-section. However, the final shape of the ceramic laminate 1 is not limited to the barrel shape as in this embodiment, but may be of a circular, hexagonal or octagonal cross-section.

As stated above, according to the present invention, throughout all the processes for producing the ceramic laminate 1, the green sheet 11 is not individually treated. That is, the inner electrode is printed on the green sheet 11 which has not been peeled off from the carrier film 12, and the green sheet piece 17 is stacked simultaneously with being punched from the green sheet 11.

Accordingly, in this embodiment, it is possible to print the inner electrode 21 and punch the printed portion while the green sheet 11 is brought into tight contact with the carrier film 12 so that the shape thereof is not deformed. Thereby, the green sheet pieces 17 free from folding, creasing, cracking or dry shrinkage are easily obtained. Also, as the stacking of the green sheet piece 17 is carried out in the central space 343 of the Thomson punch 340 simultaneously with the punching thereof, it is possible to form the green laminate 35 while maintaining a good quality of the green sheet piece 17 free from cracking or other problems.

Through the thermal press-bonding process S4 and the calcination process S5, the high quality green laminate 35 is converted to the ceramic laminate 1 free from defects such as crack or others.

Thus, according to this embodiment, it is possible to produce the ceramic laminate 1 having no defects caused by folding, creasing, cracking or dry shrinkage of the green sheet 11.

(Second Embodiment)

In this embodiment, instead of the roll-type carrier film in the first embodiment, a carrier film sheet 120 is used as shown in FIG. 10. Thus, according to this embodiment, the sheet-forming process S1, the inner electrode printing process S2 and the punching-stacking process S3 are separately carried out, which are simultaneously carried out in the first embodiment. Details of this embodiment will be concretely described below.

In this embodiment, the sheet-forming process S1 is first carried out. In this process, a green sheet 110 having a predetermined size is formed by coating a carrier film sheet 120 with the slurry to have a predetermined thickness.

Then, as shown in the drawing, the inner electrode printing process S2 is carried out. In this process, the carrier film sheet 120 holding the green sheet 110 is set up in an inner electrode printer in which an Ag—Pd paste is printed as inner electrodes 21 through a screen 2. The screen 2 has a pattern 20 corresponding to a plurality of inner electrodes to be formed in one green sheet. In such a manner, one screen printing is carried out on one green sheet 110.

Then, as shown in the drawing, the punching-stacking process S3 is carried out. In this process, the green sheet 110 held on the carrier film sheet 120 is set up in the punching-stacking device 3 having five Thomson punches 340 coupled together. The punching-stacking device 3 is sequentially located at a predetermined position and punches the green sheet to form the green sheet pieces 17 which are sequentially stacked in the central space 343 of the Thomson punch 340. This cycle is repeated to sequentially punch the green sheet pieces from the green sheet 110 to form the green laminate 35 in which a predetermined number of the green sheet pieces 17 are stacked together (see FIG. 7).

The structure, the operation and the effect other than the above are the same as those in the first embodiment.

According to this embodiment, a method for producing the ceramic laminate 1 causing few defects in the green sheet and the green sheet piece 17 such as folding, creasing, cracking or dry shrinkage can be carried out by the combination of relatively small devices.

(Third Embodiment)

This embodiment has been made on the basis of the coupled punching-stacking device used in the first embodiment while somewhat changing the structure thereof.

The coupled punching-stacking device 61 in this embodiment has an upper Thomson punch section 611 which is not movable in the punching direction and a lower pressing plate 612 coupled to a hydraulic cylinder (not shown) to be movable in the punching direction. The upper Thomson punch section 611 and the lower pressing plate section 612 are disposed opposite to each other while interposing the carrier film 12 holding the green sheet 11 between the two.

In this embodiment, the coupled punching-stacking device 61 is a five-coupled punching-stacking device 3.

As shown in FIG. 13, the upper Thomson punch section 611 includes a Thomson punch holder 320, a Thomson punch 340 having a central space 343, and a stacking weight 330 slidable in the vertical direction in the central space 343. That is, the upper Thomson punch section 611 has the same function as that of the punching-stacking device in the first embodiment, except for a stroke mechanism.

As shown in FIG. 13, the pressing plate section 612 has a generally flat placement surface 620 for supporting the carrier film 12 carrying the green sheet 11 thereon and a film suction mechanism 650 for suckingly holding the carrier film 12.

The film suction mechanism 650 includes a negative pressure chamber 651 provided in the interior of the pressing plate 612, a suction pipe 653 for sucking air in the negative pressure chamber 651, and vacuum holes 655 communicating with the negative pressure chamber 651 and opened on the placement surface 620. This film suction mechanism 650 sucks air through the vacuum holes 655 to suckingly hold the carrier film 12 on the placement table 620.

The placement surface 620 of the pressing plate 612 has a covered film layer 625, for example, of Teflon (polytetrafluoroethylene) (R) for smoothly feeding the carrier film 12.

Further, the pressing plate 612 is adapted to define a predetermined gap between the placement surface 620 of the pressing plate 612 located at the upper position and the edge of the Thomson punch, which is the same as the relationship between the edge of the Thomson punch and the-working table in the first embodiment, as shown in FIG. 5. In this regard, the predetermined gap is a gap t corresponding to a thickness of the carrier film 12 plus 5 to 10% of a thickness of the green sheet 11.

That is, a stroke of the pressing plate 612 is regulated so that the edge of the Thomson punch 340 reaches a position corresponding to 90 to 95% of the thickness of the green sheet 11 but does not reach the carrier film 12.

When the green sheet piece 17 is punched by using the punching-stacking device 61, the carrier film 12 is first advanced in the longitudinal direction to locate a portion of the green sheet 11 to be punched at a working position of the Thomson punch 340 as shown in FIG. 13. Thereafter, the movement of the carrier film 12 in the longitudinal direction is made to stop.

As shown in FIG. 14, the pressing plate 612 moves toward the upper Thomson punch section 611 to punch the green sheet piece 17 from the green sheet 11 held by the carrier film 12. The punched green sheet piece 17 is sequentially stacked in the central space 343 of the Thomson punch 340. In this regard, the stacking mechanism is similar to that in the first embodiment.

According to the method for producing the ceramic laminate by using the above-mentioned punching-stacking device 61, it is possible to produce the ceramic laminate at a high yield, in which 100 green sheet pieces or more having a thickness as thin as 100 μm or less are stacked. According to this punching-stacking device 61, a stress applied to the green sheet pieces 17 stacked in the Thomson punch 340 becomes small, and it is possible to speed up the punching period to effectively produce the ceramic laminate.

The other structure, operation and effect are the same as in the first embodiment. Also, as shown in FIG. 15, the upper Thomson punch section 611 in the punching-stacking device 61 may be arranged generally in the horizontal direction.

Further, instead of the roll-shaped carrier film 12, a carrier film sheet may be used, as in the second embodiment relative to the first embodiment, so that the sheet-forming process, the inner electrode printing process and the punching-stacking process are independently carried out.

While the movement of the carrier film 12 in the longitudinal direction is once stopped when the green sheet piece 17 is punched in this embodiment, the punching process may be carried out without stopping the carrier film 12. In the latter structure, the Thomson punch 340 itself moves in the longitudinal direction of the carrier film 12 at a constant speed so that the position of the Thomson punch 340 relative to the carrier film 12 is fixed when the green sheet piece 17 is punched.

In this case, it is necessary to return the Thomson punch 340 to a predetermined position in the longitudinal direction every time when the green sheet piece 17 has been punched. However, according to this method, the green sheet piece 17 can be effectively punched while continuously feeding the carrier film 12 in the longitudinal direction.

The preferred aspects of the present invention will be described below.

Preferably, the green sheet piece is punched by a Thomson punch having a central space in which the green sheet pieces are stacked so that the punching process and the stacking process are simultaneously carried out.

In this regard, the Thomson punch is a press punch for carrying out a Thomson process. The Thomson process is a kind of press treatment for punching a sheet piece having a predetermined shape from a sheet-like objective.

A Thomson edge is provided at a tip end of the Thomson punch, to define a closed curve substantially the same as a shape to be punched. Also, the Thomson punch has a recess inside the closed curve having a depth equal to a punched thickness or more. Therefore, the objective is cut to have substantially the same shape as the closed curve of the Thomson edge without deformation caused by surface pressure.

In the present invention, the Thomson punch having the central space is preferably used as described above. In this case, it is possible to simultaneously carry out the punching process and the stacking process. That is, the green sheet piece is immediately stacked as it is punched. As the green sheet piece is not separated from the carrier film during the processes from the punching process to the stacking process, no defect occurs in the green sheet piece, such as folding, creasing, cracking or dry shrinkage throughout the punching process to the stacking process.

When the green sheet pieces are stacked in the central space, a pressure is preferably applied so that the green pieces are brought into tight contact with each other in the stacking direction.

In this case, the punching, stacking and pressing of the green sheet pieces are simultaneously carried out. Thus, the green sheet pieces are brought into tight contact with each other within the central space of the Thompson punch. Therefore, it is possible to prevent the laminate from falling down or deforming when the same is taken out from the Thomson punch. No defect occurs in the green sheet piece, such as folding, creasing, cracking or dry shrinkage after the same are stacked together.

While the proper pressure may vary in accordance with cross-sectional areas of the laminate, it is suitable in a range from 10 g to 1.5 kg. If the pressure is less than 10 g, the effect for the green sheet pieces to be in tight contact with each other becomes insufficient. While, if exceeding 1.5 kg, there is a risk in that the green laminate formed in the central space of the Thomson punch may deform.

In the punching process, the Thomson punch is preferably fixed at least in the punching direction, and the carrier film holding the green sheet moves toward the Thomson punch so that the green sheet is brought into press-contact with the Thomson punch to punch only the green sheet piece.

In this case, it is possible to punch the green sheet piece without moving the Thomson punch to the green sheet but while moving the green sheet to be in press-contact with the Thomson punch. Therefore, no stress or others which is a cause of the unfavorable calcination is generated in the green laminate formed in the central space of the Thomson punch.

The above-mentioned effect is particularly significant when a thickness of the green sheet is approximately 200 μm or less, when the punching period is one second or less, or when the number of the green sheet pieces in the laminate is 100 or more. This is because a stress is liable to be applied to the green laminate in the central space of the Thomson punch in these cases.

In the punching process, preferably, a pressing plate is disposed, on one hand, opposite to the Thomson punch while intervening the green sheet and the carrier film for holding the green sheet, and on the other hand, opposite to the carrier film, and moves toward the Thomson punch to punch the green sheet solely.

In this case, it is possible to accurately press the green sheet carried by the carrier film onto the Thomson punch. Accordingly, a precisely punched green sheet piece is obtainable as in the case wherein the green sheet piece is punched while moving the Thomson punch toward the green sheet.

The pressing plate preferably has a suction mechanism for suckingly holding the carrier film.

In this case, it is possible to promptly separate the carrier film from the Thomson punch simultaneously with the retreat of the pressing plate after the green sheet piece has been punched. Thus, even if the punching period becomes shorter, the punching process can follow the same to punch more green sheet pieces per unit time.

A surface of the pressing plate to be in contact with the carrier film is preferably subjected to a surface treatment for facilitating the slip of the carrier film thereon.

In this case, no stress generates in the green sheet carried on the carrier film caused by the frictional force between the pressing plate and the carrier plate. Thus, the ceramic laminate consisting of the green sheet pieces punched out from the green sheet has a good quality.

The surface treatment is particularly advantageous when the green sheet pieces are sequentially punched from the green sheet carried by the carrier film of a roll shape while continuously feeding the latter.

In this regard, a coating of Teflon (R), titanium, diamond or others is preferably formed by the surface treatment.

The green sheet preferably has a thickness of 300 μm or less.

In this case, as the green sheet is very weak and liable to fold, crease or crack, the operation and effect of the present invention is particularly advantageous.

The green laminate is constituted by 100 layers or more of the green sheet pieces, each having a thickness of 100 μm or less.

If the thickness is 100 μm or less, the green sheet piece is particularly weak to be liable to fold, crease or crack. When 100 layers or more of the weak green sheet pieces are stacked, there is a risk in that problems may occur in the calcination process. Also, it is difficult to shorten the punching period in the punching process in such a case. Thus, the operation and effect of the present invention is particularly advantageous.

While the invention has been described by reference to specific embodiments chosen for the purpose of illustration, it should be apparent that numerous modification could be made thereto by those skilled in the art without departing the basic concept and scope of the invention.

What is claimed is:

1. A method for producing a ceramic laminate, comprising
a sheet-forming process for forming a green sheet by placing a raw ceramic material on a carrier film,
a punching process for punching a green sheet piece of a predetermined shape from the green sheet,
a stacking process for sequentially stacking a plurality of the green sheet pieces to form a green laminate, and
a calcination process for calcining the green laminate to obtain a ceramic laminate consisting of a plurality of ceramic layers,
wherein, in the punching process, the only green sheet piece is punched while the green sheet is held on the carrier film.

2. A method for producing a ceramic laminate as defined by claim 1, wherein the green sheet piece is punched by a Thomson punch having a central space in which the green sheet pieces are stacked so that the punching process and the stacking process are simultaneously carried out.

3. A method for producing a ceramic laminate as defined by claim 2, wherein, when the green sheet pieces are stacked in the central space, a pressure is applied so that the green pieces are brought into tight contact with each other in the stacking direction.

4. A method for producing a ceramic laminate as defined by claim 2, wherein, in the punching process, the Thomson punch is fixed at least in the punching direction, and the carrier film holding the green sheet moves toward the Thomson punch so that the green sheet is brought into press-contact with the Thomson punch to punch only the green sheet piece.

5. A method for producing a ceramic laminate as defined by claim 4, wherein, in the punching process, a pressing plate is disposed, on one hand, opposite to the Thomson punch while intervening the green sheet and the carrier film for holding the green sheet, and on the other hand, opposite to the carrier film, and moves toward the Thomson punch to punch only the green sheet.

6. A method for producing a ceramic laminate as defined by claim 5, wherein the pressing plate has a suction mechanism for suckingly holding the carrier film.

7. A method for producing a ceramic laminate as defined by claim 4, wherein a surface of the pressing plate to be in contact with the carrier film is subjected to a surface treatment for facilitating slippage of the carrier film thereon.

8. A method for producing a ceramic laminate as defined by claim 1, wherein the green sheet has a thickness of 300 μm or less.

9. A method for producing a ceramic laminate as defined by claim 4, wherein the green laminate is constituted by 50 layers or more of the green sheet pieces, each having a thickness of 150 μm or less.

10. A method for producing a ceramic laminate, comprising
a sheet-forming process for forming a green sheet by placing a raw ceramic material on a carrier film,
a printing process for printing an electrode paste on the green sheet,
a punching-stacking process for punching a green sheet piece from the green sheet and stacking the green sheet pieces to obtain a green laminate, and
a calcination process for calcining the green laminate to obtain a ceramic laminate in which a ceramic layer and an electrode layer are alternately stacked,
wherein in the punching-stacking process, the green sheet piece is punched by a Thomson punch having a central space in which the green sheet pieces are stacked.
